(19) United States
(12) Patent Application Publication
(10) Pub. No.: US 2012/0290356 A1
(43) Pub. Date: Nov. 15, 2012

(54) METHOD FOR OPERATING AN ONLINE SERVICE FOR EVALUATING AND AWARDING WEBSITES

(75) Inventor: In Ho Yu, Seoul (KR)

(73) Assignees: IMPRESS CNC CO., LTD., Seoul (KR); In Ho YU, Seoul (KR)

(21) Appl. No.: 13/515,253

(22) PCT Filed: Dec. 9, 2010
(86) PCT No.: PCT/KR10/08819

§ 371 Date: Jun. 11, 2012

(30) Foreign Application Priority Data
Dec. 10, 2009 (KR) 10-2009-0122445

(51) Int. Cl. G06Q 30/02

(52) U.S. Cl. 705/7.29

(57) ABSTRACT

The present invention relates to a method for operating an online service for evaluating and awarding websites. The objective for implementing the technology is to provide a method for operating an online service for evaluating and awarding websites, which enables an evaluation service operator server to invite public participation for providing an award and to receive applications from a variety of newly constructed or renewed websites in each field, and which selects, on the basis of preset evaluation criteria, a website that provides excellent service, and awards the selected website, to thereby propose website construction technologies and technical changes and direction. Therefore, to achieve the above objective, the present invention comprises the following specific means: an evaluation service operator server including an automatic information-processing unit, a registration applying unit, an evaluation board selecting unit, a review and evaluation processing unit, an information and data searching unit and an evaluation report generating unit; a website evaluation application server which applies and registers websites to be evaluated to the evaluation service operator server; and a user server which provides review and evaluation information on the applied websites. In addition, the objective of the present invention is accomplished by using the above-described system, and performing an evaluation registration applying step, a registration-type selecting step, an evaluation board selecting step, a review and evaluation preparing step, a review and evaluating step, a ranking processing step, a winner selecting step, and an award result information processing step.

### TECHNICAL FIELD

The present invention relates to a method for operation a service for evaluating and awarding websites, more particularly, a method for operating an online service for evaluating and awarding websites wherein a variety of websites in each field newly constructed or renewed over a certain period are publicly collected as award nomination and the publicly collected websites in each field are examined and selected through a preset evaluation criteria, thus are given a chance of getting an award, hence change and direction of website construction technologies and web design technologies can be presented and internet profit model of new type can be created through a series of such services.

### BACKGROUND ART

In a variety of fields of politics, economy, society, culture, education, corporation etc., the websites (homepages) produced for the purpose of providing information and obtaining commercial profit is common online information providing means prepared for enabling a number of unspecific users to visit the website through the internet and buy and obtain information, goods, service etc. required by the users themselves anytime, anywhere while not tied to time and space, and the websites are generally identified and distinguished by address or URL (uniform resource locator) of the registered homepage, thereby inducing access of the users.

However, the number of the websites produced for the above purpose is as enormous as countless, for example, multi billion or more, and in this connection, the greatest worry of operators of the websites is which distinguished strategy they prepare for a number of unspecific users and how many users they can indeed induce to visit their own homepages through such distinguished strategy.

For example, if search frequency of the website of the operator is relatively raised due to increase of access of the users, degree of recognition and popularity of a corporation or an individual as the subject of operation of the website are naturally increased, or if the information provided through the website is an article of commerce, advertising effect for the article of commerce is widely spread, whereby sales of the operator is increased and also new potential consumers are found, hence an effect of inducing them to buy the article of commerce is also obtained, and in addition, communication with the users is also actively done.

However, since these days according to change of environment of the drastically developed internet, requirement and desire of expectation of the users for the websites are daily increased, and in addition to it, new competitors and new medium also continually appear, it is very important to prepare a strategy of distinguished form for correctly grasping the requirement of the customers and in the basis of it giving salience to own website, but most of the websites have a problem that they cannot properly deal with it.

For example, though it is necessary to prepare new strategy through survey of actual condition and degree of preference of the users, plan differentiation from competitors by correctly grasping trend of market of interest and in addition through objective diagnosis of market value and website service of own company find various corresponding solutions, much expense, time, labor and effort are required for progressing a series of such matters (survey of actual condition and degree of preference of the users, grasping of the trend of market of interest, diagnosis and evaluation of market value and provided service etc.), and in this connection, a problem occurs that an individual or operators of small and medium scale websites with relatively insignificant capital power and information power cannot help being left behind such a competition due to inferior environmental factors.

Meanwhile, in recent, as a solution for partially solving the problems regarding operation of website as described above, a method for ranking evaluation of websites has been devised in which degree of preference of the websites exposed through the internet is evaluated by ranking, thereby providing users with information of better quality, and which on the other hand enables operators of the websites to grasp the trend of market of interest through list of the ranked websites and simultaneously improve the problems regarding operation of website through such information (Korean Patent Application No. 2000-30327).

However, in the method for ranking evaluation of websites devised as above, a number of unspecific users surfing the websites through the internet are registered and secured as evaluation member, and thereafter, extraction and analysis of the connection number, connection residence time, page view, connection speed etc. for each website by the secured members are carried out, thereby imparting evaluation ranking of the websites.

Therefore, the method for ranking evaluation of websites as described above is only based on mere connection information of the registered evaluation members, and in this connection such an evaluation method causes a serious problem that malicious and strategic unfair clicks etc. may be sometimes induced, hence the ranking may be manipulated at any times. In addition, due to such incorrect evaluation result, the reliability and morality of the evaluation method are lost, hence a problem appears that substantial operation of services is impossible.

Meanwhile, alternatively, most of conventionally used website evaluation methods merely enumerate only ranking list, but does not utterly present a solution for raising status of internet and web-related industrial field through mutual technical interchange, for example, a solution for presenting change and direction of website construction technologies and web design technologies, inducing benchmarking through analysis of technologies of competitors, diagnosing other problems regarding operation of website and then finding solution therefor. Therefore, in operation of a series of services, various problems still exist that the operation is very uneconomical, inefficient and not systematized.

### DISCLOSURE OF THE INVENTION

Therefore, the present invention has been devised in order to solve all of the problems of the conventional method for evaluating websites.

An object of the present invention is to provide a method for operating an online service for evaluating and awarding websites wherein a variety of newly constructed or renewed websites in each field are applied and received as award nomination through public collection for award by an evaluation service operator server and excellent websites are selected from the publicly collected websites to be awarded through a preset evaluation criteria, for example, a point-allotting criteria for each item such as design, user interface (UI), technologies, contents, brand, promotion, marketing, service etc., hence website construction technologies and accordingly change and direction of the technologies can be presented, and also analysis of technologies of competitors and selective benchmarking are enabled through a series of such public collection processes, and in addition, problems regarding operation of each website and something to improve the websites etc. are diagnosed and then corresponding solutions are also presented, thereby giving a chance of creating new value, and based on it, new marketing strategy through the websites can be prepared.

Another object of the present invention is to provide a method for operating an online service for evaluating and awarding websites wherein fairness, speciality and reliability of the review are enhanced by constructing a special evaluation board server consisting of web technology-related expert group and a common evaluation board server without specific limitation, and in addition both of viewpoints of common users regarding the websites and viewpoints of web technology experts can be secured through constructing of such servers, hence review comments of various viewpoints can be delivered without bias to specific group, and based on various comments of the web technology-related expert group, for example, experts of educational circle and actual operation in relevant field, realistic improvement plans having practical applicability can be presented, and thus reality and differentiation are enhanced.

Meanwhile, yet another object of the present invention is to provide a method for operating an online service for evaluating and awarding websites wherein information regarding the corporations specialized for construction of websites, information regarding the corporations awarded in website evaluation, and evaluation and analysis report for each website participating in public collection for award are provided as periodically published data information of e-book form obtained through service for evaluating and awarding websites, hence trend of various internet information and culture such as planning, design and applied technologies etc. of excellent websites for each field can be seen, and in addition, survey of actual condition of the users, analysis of competitors and position of own company in web-related market can be also checked and grasped through such information.

In this respect, as concrete means of the method for operating an online service for evaluating and awarding websites according to the present invention for achieving the above object, provided are evaluation service operator server comprising an automatic information processing unit, a registration applying unit, an evaluation board selecting unit, a review and evaluation processing unit, an information data searching unit and an evaluation report generating unit; website evaluation applicant server which applies and registers the websites to be evaluated in the evaluation service operator server; and user server providing information for review and evaluation for the applied websites.

Furthermore, the object is achieved by carrying out an evaluation registration applying step, registration type selecting step, evaluation board selecting step, review and evaluation preparing step, review and evaluation step, evaluation ranking result processing step, award winner selecting step and award result information processing step by utilizing a series of the system as described above.

Therefore, the method for operating an online service for evaluating and awarding websites according to the present invention provides an effect that a variety of websites in each field are applied and received as award nomination through public collection for award by the evaluation service operator server and excellent websites are evaluated and selected from the publicly collected websites to be awarded, hence website construction technologies and accordingly change and direction of the technologies can be presented and also analysis of technologies of competitors and selective benchmarking are enabled, thus new marketing strategy can be prepared.

Furthermore, the present invention provide an effect that fairness, speciality and reliability of the review are enhanced by constructing a special evaluation board server and a common evaluation board server and review comments of various viewpoints can be delivered through constructing of such servers without bias to specific group, thus more realistic and differentiated improvement plans can be presented.

Furthermore, by producing the evaluation and analysis report for each website, trend of various internet information and culture such as planning, design and applied technologies etc. of excellent websites for each field can be seen, and survey of actual condition of the users, analysis of competitors and position of own company in web-related market can be also checked and grasped through such information, which provides very useful expectation effect.

### BRIEF DESCRIPTION OF THE DRAWINGS

FIG. 1 shows schematic construction of a system for online evaluation of the websites applied to the present invention.

FIG. 2 shows a schematic view of a registration applying unit applied to the present invention.

FIG. 3 shows a schematic view of an evaluation board selecting unit applied to the present invention.

FIG. 4 shows a schematic view of a review and evaluation processing unit applied to the present invention.

FIG. 5 shows a schematic view of an information data searching unit applied to the present invention.

FIG. 7 is a whole conceptual view of the method for operating a service for evaluating and awarding websites according to the present invention.

FIG. 8 is a flow chart of the method for operating a service for evaluating and awarding websites according to the present invention.

### LIST OF REFERENCE NUMERALS

1: evaluation service operator server
2: individual website evaluation applicant server
3: user server
11: automatic information processing unit
12: registration applying unit
13: evaluation board selecting unit
14: review and evaluation processing unit
15: information data searching unit
16: evaluation report generating unit
31: special evaluation board server
32: common evaluation board server
S1: evaluation registration applying step
S2: registration type selecting step
S3: evaluation board selecting step
S4: review and evaluation preparing step
S5: review and evaluation step
S6: evaluation ranking result processing step
S7: award winner selecting step
S8: award result information processing step.

### MODES FOR CARRYING OUT THE INVENTION

Hereinafter, construction of preferred example of a method for operating an online service for evaluating and awarding websites according to the present invention will be described in detail with reference to the attached drawings.

In this connection, referring to the attached drawings, schematic construction of a system of the present invention will be described as follows:

The system comprises an evaluation service operator server (1), an individual website evaluation applicant server (2), and a user server (3).

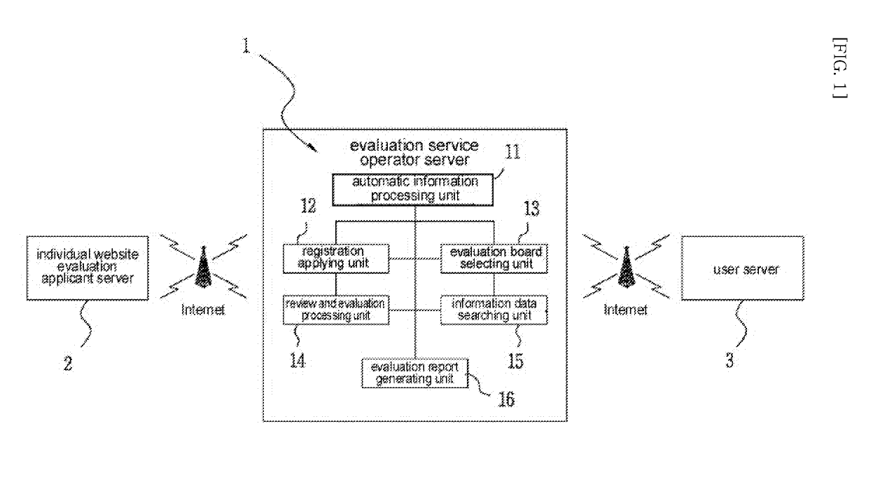

In this connection, in the system construction of the present invention, first, the evaluation service operator server (1) is a main element of the present invention provided for evaluating, selecting and awarding excellent websites through the internet and providing information regarding a series of website related technologies etc. obtained through the evaluation process, and in this connection, the evaluation service operator server (1) comprises an automatic information processing unit (11), and in addition to this unit, preferably further has registration applying unit (12), evaluation board selecting unit (13), review and evaluation processing unit (14), information data searching unit (15) and evaluation report generating unit (16), as illustrated in FIG. 1.

In this connection, in the evaluation service operator server (1), the automatic information processing unit (11) is a common online medium means provided for distinguishing the individual website evaluation applicant server (2) and user server (3) described in the following according to the type of service provision and allowing communication with them in real time on the internet, and such an automatic information processing unit (11) takes an another server construction, and provided through the automatic information processing unit (11) of the server construction are member registration service, text information and message transmission service, menu operation service related to construction of web browser, and service for transmitting a variety of data such as voice, streaming video image, still image.

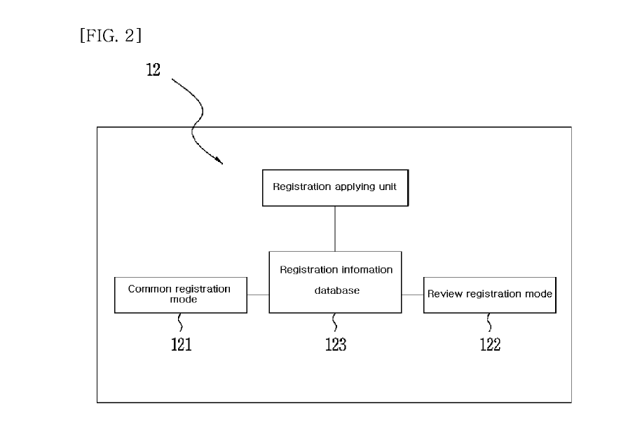

Furthermore, in the evaluation service operator server (1), the registration applying unit (12) is means for, from the individual website evaluation applicant server (2) described below, receiving information regarding individual website desired to be evaluated or to be registered as award nomination, for example, detailed information such as the name, address and business field of the website (homepage) operated by an individual or corporation and then registering and accepting them. Such a registration applying unit (12) is constructed by web program consisting of common registration mode (121), review registration mode (122) and registration information database (123), as illustrated in FIG. 2.

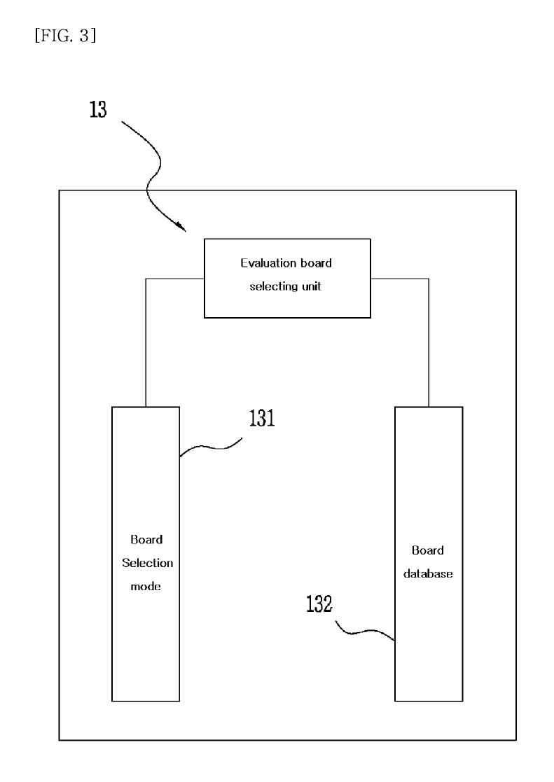

Furthermore, in the evaluation service operator server (1), the evaluation board selecting unit (13) is means for receiving applications for member admission from a number of unspecific user servers, for example, all of the internet users such as an individual, corporations, research institutes, educational institutes etc., classifying the admitted members (user servers) into special evaluation board server (31) and common evaluation board server (32) according to a preset selection criteria, as illustrated in FIG. 3. Such an evaluation board selecting unit (13) is constructed by web program consisting of board selection mode (131) and board database (132). as illustrated in FIG. 3.

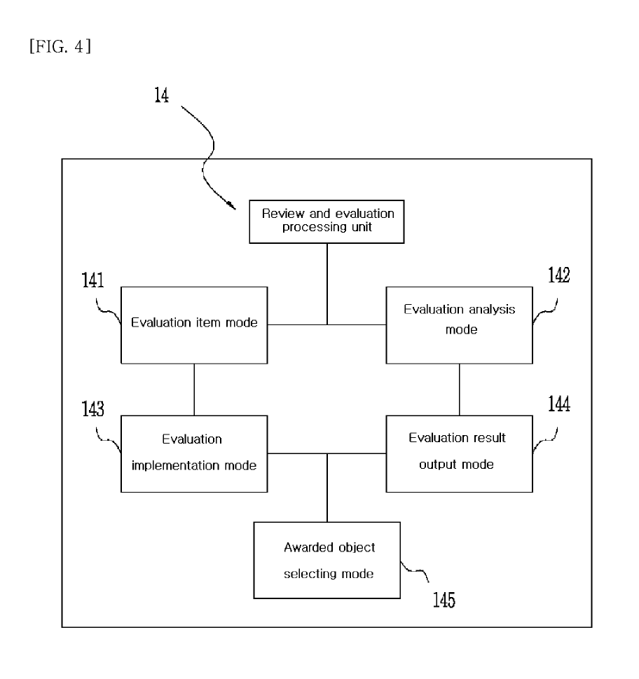

Furthermore, in the evaluation service operator server (1), the review and evaluation processing unit (14) is means for analyzing and evaluating each website to be evaluated stored as data in the above-described registration applying unit (12) according to predefined items and instructions. Such a review and evaluation processing unit (14) is constructed by web program consisting of evaluation item mode (141), evaluation analysis mode (142), evaluation implementation mode (143), evaluation result output mode (144) and awarded object selection mode (145), as illustrated in FIG. 4.

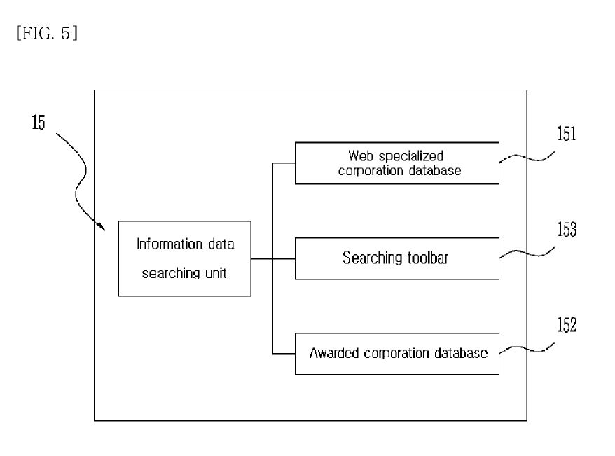

Furthermore, in the evaluation service operator server (1), the information data searching unit (15) is means for managing, storing and searching information about corporations specializing in construction of the websites and information list related to the websites selected (awarded) as an excellent website through an evaluation process. Such an information data searching unit (15) is constructed by web program consisting of web specialized corporation database (151), awarded corporation database (152) and searching toolbar (153), as illustrated in FIG. 5.

Furthermore, in the evaluation service operator server (1), the evaluation report generating unit (16) is means for minutely searching and analyzing the registered websites to be evaluated and providing the results as charged information. Such an evaluation report generating unit (16) is constructed by a kind of data edition program for inputting, editing and storing data relating to characters and images etc., collecting various dispersed data information through transmission/reception functions and also enabling the processing and editing of another data such as sound, streaming video, still image etc.

Meanwhile, in the system construction of the present invention, second, the individual website evaluation applicant server (2) can be any servers which operate the websites on internet regardless of the position or field and scale of all of the internet users, for example, an individual, corporations, research institutes, educational institutes etc., that want evaluation of newly constructed or renewed own websites through official procedure or obtain a chance of receiving award through the evaluation. Therefore, in the present invention, it is preferred that such a conventional website operating sever is constructed as the individual website evaluation applicant server (2).

Lastly, in the system construction of the present invention, third, the user server (3) can be any of all conventional user servers which are provided with information through the internet or actively provide information through the internet regardless of the position or field and scale of an individual, corporations, research institutes, educational institutes etc. In this respect, in applying such a user server to the present invention, for the sake of detailed technical description, the user server is preferably constructed by subdividing it into the special evaluation board server (31) and common evaluation board server (32), as illustrated in FIG. 6.

At this time, for amplificatory explanation, the individual website evaluation applicant server (2) and user server (3) described above have been separately described in terms of its name of construction and function for easy technical explanation of the present invention, but the constructions of both of the individual website evaluation applicant server (2) and user server (3) are substantially identical in that they take all of the internet users as potential object, hence mutual changeable application is possible.

For example, the individual website evaluation applicant server (2) may be also the user server (3), and oppositely, the user server (3) may be also the individual website evaluation applicant server (2) to be subjected to website evaluation.

Therefore, the present invention consisting of a series of system constructions as described above realizes a method for operating a service for evaluating and awarding websites of the type differentiated from existing method by utilizing the constructed system. In this connection, preferred example of such a method for operating a service for evaluating and awarding websites will be described in detail with reference to the attached drawings.

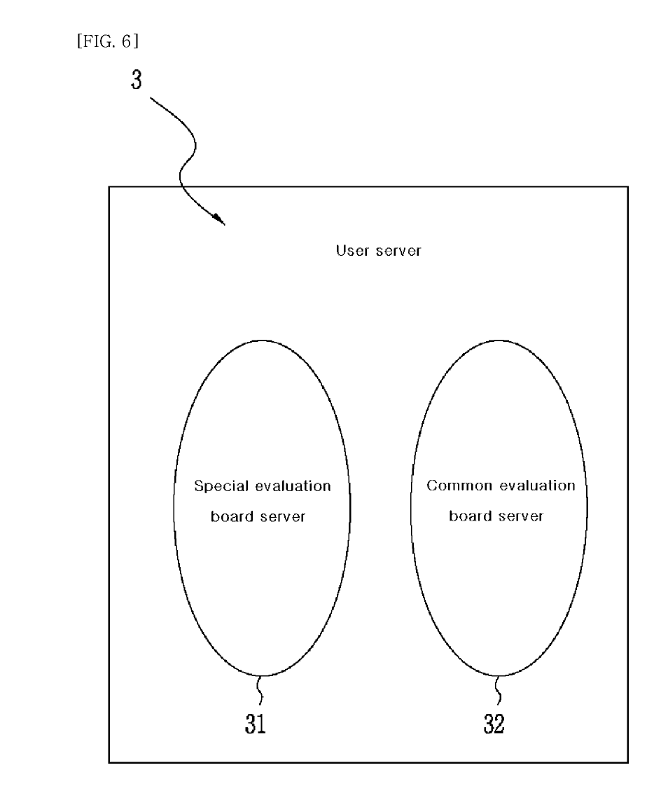

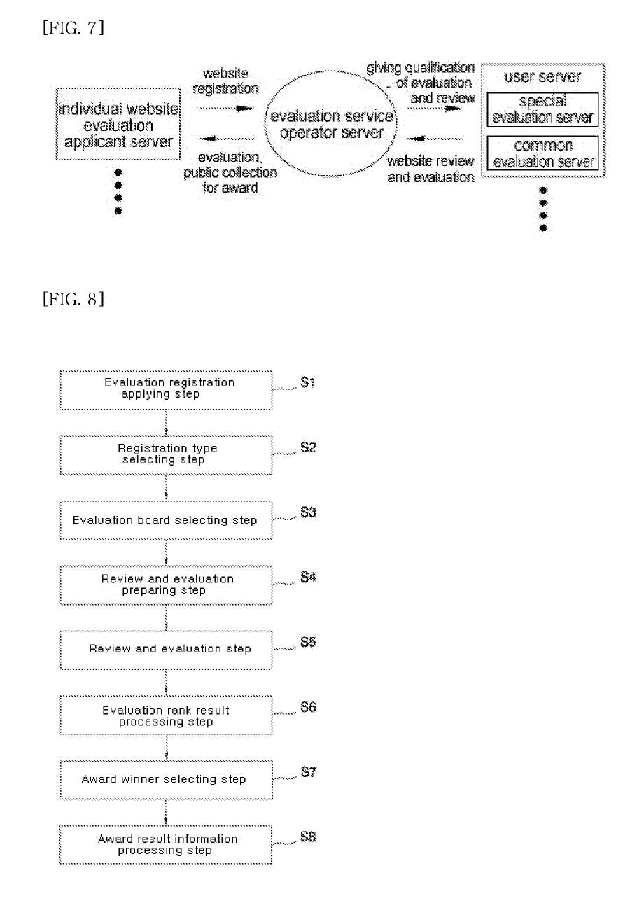

FIG. 7 is a whole conceptual view of the method for operating a service for evaluating and awarding websites according to the present invention, and FIG. 8 is a flow chart of the method for operating a service for evaluating and awarding websites according to the present invention. A series of constructions of the method will be described as follows.

The method comprises an evaluation registration applying step (S1), registration type selecting step (S2), evaluation board selecting step (S3), review and evaluation preparing step (S4), review and evaluation step (S5), evaluation ranking result processing step (S6), award winner selecting step (S7) and award result information processing step (S8).

Herein, first, the evaluation registration applying step (S1) preferably comprises linking the individual website evaluation applicant server (2) of a number of unspecific objects that want evaluation of the websites operated by themselves and obtain a chance of receiving award through the evaluation by means of the automatic information processing unit (11) provided in the evaluation service operator server (1) through online public collection by the evaluation service operator server (1), and from the linked individual website evaluation applicant server (2) receiving applicant information data necessary for registration of the websites and information data regarding the websites to be evaluated, and storing them as database in the registration applying unit (12) of the evaluation service operator server (1).

In this connection, the websites registered by the evaluation service operator server (1) are limited to websites which have been newly constructed or renewed (modified or complemented) within a period arbitrarily set by the evaluation service operator server (1), and only such websites can be registered.

In addition, for registration of the websites, the name (for corporation, its name), address, resident registration number (corporation number), telephone number, email address etc. of the applicant for registration are necessarily provided as applicant information data provided to the evaluation service operator server (1), and alternatively, necessarily provided as information data of the websites to be evaluated are the name, website address and business field (manufacturing business, financial business, service etc.) of the websites to be registered.

Furthermore, the registration type selecting step (S2) preferably comprises classifying information of the websites registered in the registration applying unit (12) through the above-described evaluation registration applying step (S1) into common registration website and nomination registration website and processing the information, by assigning again the information to the common registration mode (121) and review registration mode (122) by means of the evaluation service operator server (1) according to selective request of the registered object, i.e., the individual website evaluation applicant server (2).

In this connection, the websites classified for the common registration mode (121) correspond to a simple freely-registered object, hence are not subjected to a separate review and evaluation step, and are merely utilized in such a degree that the information of the websites is simply exposed to a number of unspecific persons, thereby obtaining advertisement effect. Alternatively, the websites registered as award nomination through the review registration mode (122) are subjected to a review and evaluation step over a certain period after further payment of a predetermined review fee arranged in the name of evaluation fee.

Furthermore, the evaluation board selecting step (S3) preferably comprises online connecting the user servers (3) of a number of unspecific objects through the automatic information processing unit (11) provided in the evaluation service operator server (1) by means of the evaluation service operator server (1), and thereafter granting membership by issuing ID and password according to online admission request of the connected user servers (3) and classifying again the user servers (3) admitted as a member into the special evaluation board server (31) and common evaluation board server (32) through the board selection mode (131) of the evaluation board selecting unit (13).

In this connection, in classifying the user servers (3) admitted as a member into the special evaluation board server (31) and common evaluation board server (32) as described above, the first, the special evaluation board server (31) prepares selection criteria data such as application qualification and application condition for it, for example, web expert who engages in a corporation having 30 or more employees and is in charge of website management and operation, professors for each field engaging in educational circles, other journalists, and grants qualification as the special evaluation board server (31) to only user servers meeting the selection criteria. Furthermore, granted to such a special evaluation board server (31) are incentive benefits associated with use of the service for evaluating and awarding websites of the present invention, for example, authority of freely registering own website in award nomination as a position of applicant for website evaluation, not as a position of evaluation board, authority of freely reading or get provision of various information stored in the evaluation service operator server, authority of attending various seminars and workshops hosted by the evaluation service operator server etc.

Alternatively, in classifying the user servers (3) admitted as a member into the special evaluation board server (31) and common evaluation board server (32), the common evaluation board server (32) has a simple membership with no separate selection criteria and is granted only an authority of giving evaluation points to the websites registered in the award nomination.

Furthermore, the review and evaluation preparing step (S4) preferably comprises subdividing the websites registered as the object to be evaluated according to the type of business fields such as general corporations, finance, product brand, shopping mall, culture, education, sports, communication etc. through the evaluation item mode (141) of the review and evaluation processing unit (14) provided in the evaluation service operator server (1) by the evaluation service operator server (1), and preparing evaluation items necessary for the review of the websites, for example, criteria for each evaluation field such as design, user interface (UI), technologies, contents, brand, promotion, marketing, service etc. and through the evaluation analysis mode (142) setting and preparing analysis manual for the items, for example, fractionated criteria such as a point-allotting criteria regarding whether web design elements have been constructed with a high degree of completeness or not, a point-allotting criteria regarding website accessibility and convenience of use thereof, a point-allotting criteria regarding effective usability of added technologies applied to the website.

Furthermore, the review and evaluation step (S5) preferably comprises directly surfing and reviewing each website stored as registration data of evaluation award nomination in the registration applying unit (12) by the special evaluation board server (31) and common evaluation board server (32) while using the above-described evaluation item and analysis manual set in the review and evaluation preparing step (S4) as an evaluation criteria and inputting evaluation points resulting from the evaluation through the evaluation implementation mode (143).

In this connection, the common evaluation board server (32) selects desired websites as many as the number set (predetermined) by the evaluation service operator server (1) among the websites registered as evaluation award nomination and inputs comments together with the points for each item to the selected websites. The special evaluation board server (31) also evaluates and reviews the websites registered as award nomination by the same way as the common evaluation board server (32), and allots the points for each item higher relative to the common evaluation board server (32), and the comments resulting from the review are of more specialized form; even problems and ways for improvement may be inputted as comments.

Furthermore, the evaluation ranking result processing step (S6) preferably comprises inputting evaluation points for each website allotted with points by the special evaluation board server (31) and common evaluation board server (32) to an evaluation result output mode (144) provided in the evaluation service operator server (1) by the evaluation service operator server (1) and, according to integrated points, producing list data of overall ranking of the websites as the object to be evaluated, for example, integrated award data such as highest award, innovation award, special award etc., and in addition thereto, producing list data of the ranking for each item according to the points for each item, for example, award data for each item such as design award, brand award, technical award, contents award etc.

Furthermore, the evaluation award winner selecting step (S7) preferably comprises assigning list data of overall ranking and list data of ranking for each item of the websites to be evaluated obtained in the above-described evaluation ranking result processing step (S6) to the awarded object selecting mode (145) provided in the evaluation service operator server (1) by the evaluation service operator server (1) to select and extract the websites to be awarded while distinguishing the websites by overall ranking, ranking for each field and ranking for each item, and providing award breakdown and evaluation comments of the selected and extracted websites as display information through web screen of the awarded object selecting mode (145).

Lastly, the award result information processing step (S8) preferably comprises transmitting sectionalized award breakdown of the selected awarded websites, the names of the websites, operators and producers of the selected awarded websites, and evaluation information of the websites, for example, information regarding detailed comments with respect to merit and demerit of the websites evaluated and represented for each item, something to improve the websites and future direction for the websites etc. to the information data searching unit (15) provided in the evaluation service operator server (1) by the evaluation service operator server (1) and registering and storing the transmitted information in the awarded corporation database (152).

In this connection, the information registered and stored in the above-described awarded corporation database (152) is provided as free information to the user server (3) admitted as a member, the individual website evaluation applicant server (2) and all of other internet users through the searching toolbar (153) provided in the information data searching unit (15), for example information output process according to the input of words for search.

Meanwhile, in providing the service for evaluating and awarding websites through a series of operation methods as described above, the evaluation service operator server (1) extracts only user servers corresponding to corporations specialized for construction of websites among the user servers (3) admitted as a member based on the information provided at the time of admission, for example, extracts information such as the names, addresses, the number of employees, annual sales scale of the corporations for executing website construction, internet construction, internet consulting or other internet related services, and separately storing the extracted information list in the web specialized corporation database (151) provided in the information data searching unit (15), and further provides services of allowing the information list thus stored regarding the user servers specialized for construction of websites to be searched and identified through the searching toolbar (153).

Furthermore, in providing the service for evaluating and awarding websites through a series of operation methods as described above, the evaluation service operator server (1) further provides service of generating evaluation report as additional charged service according to selective request of the individual website evaluation applicant server (2).

For example, the evaluation service operator server asks the evaluation report generating unit (16) to generate the evaluation reports for the admitted websites according to the request from the individual website evaluation applicant server (2) which tries benchmarking through analysis of change and direction of website construction technologies and web design technologies and technologies of competitors and wants to more concretely grasp operational problems of own website etc.

If request for generating the evaluation report and corresponding payment of fee have been done, the evaluation service operator server (1) concretely collects and analyzes materials regarding online research on the actual condition of users, analysis of competitors and components of the requested website, and generates data information report of e-book form for the collected and analyzed materials through the evaluation report generating unit (16) and provides the report to requester, i.e., the individual website evaluation applicant server (2).

Alternatively, the evaluation service operator server (1) providing a series of services for evaluating and awarding websites as described above further provides additional information services for the user server (3) admitted as a member, the individual website evaluation applicant server (2), a number of other unspecific internet users hoping to obtain information related to website technologies, and such additional information services comprise editing and processing the information obtained through a series of services for evaluating and awarding websites as described above, for example, lists of information regarding the corporations specialized for construction of websites, information regarding the corporations awarded in website evaluation, information regarding the websites participating in public collection for award etc. by data such as characters, images, stream video etc. and providing it as periodically published information of e-book form through registration database, which does not also depart from the scope of the present invention.

What is claimed:

1. A method for operation a service for evaluating and awarding websites, comprising:
an evaluation registration applying step (S1) in which an evaluation service operator server (1) links individual website evaluation applicant server (2) that want to be subjected to website evaluation and registered as award nomination through online public collection by means of an automatic information processing unit (11) and from the linked individual website evaluation applicant server (2) receives applicant information data necessary for registration and information data regarding the websites to be evaluated and stores the thus received information data in a registration information database (123) provided in a registration applying unit (12);
a registration type selecting step (S2) in which the evaluation service operator server (1) classifies information of the websites registered in the registration applying unit (12) into common registration website and award nomination registration website through common registration mode (121) and review registration mode (122) according to request of the individual website evaluation applicant server (2) and processes the information;
an evaluation board selecting step (S3) in which the evaluation service operator server (1) connects user servers (3) through the automatic information processing unit (11) and issues ID and password according to online admission request of the user servers (3) and the evaluation service operator server (1) classifies the user servers (3) requested for online admission into special evaluation board server (31) and common evaluation board server (32) through board selection mode (131) of an evaluation board selecting unit (13);
a review and evaluation preparing step (S4) in which the evaluation service operator server (1) classifies the registered websites according to the type of field through a review and evaluation processing unit (14) and sets evaluation items necessary for the review and analysis manual for the items;
a review and evaluation step (S5) in which the special evaluation board server (31) and common evaluation board server (32) classified in the evaluation board selecting step (S3) review each website stored in the registration applying unit (12) while using the evaluation item and analysis manual set in the review and evaluation preparing step (S4) as an evaluation criteria and inputs evaluation points resulting from the evaluation in evaluation implementation mode (143);
an evaluation ranking result processing step (S6) in which the evaluation service operator server (1) inputs evaluation points allotted by the special evaluation board server (31) and common evaluation board server (32) to an evaluation result output mode (144) and produces list data of overall ranking of the websites according to integrated points and list data of ranking for each item according to the points for each item;
an evaluation award winner selecting step (S7) in which the evaluation service operator server (1) assigns list data of overall ranking and list data of ranking for each item of the websites obtained through the evaluation ranking result processing step (S6) to awarded object selecting mode (145) to select the websites to be awarded while distinguishing the websites by the overall ranking, ranking for each field and ranking for each item and provide award breakdown and evaluation comments of the selected websites as display information through web screen of the awarded object selecting mode (145); and
an award result information processing step (S8) in which the evaluation service operator server (1) transmits the award breakdown of the websites selected as award nomination classified by the overall ranking, ranking for each field and ranking for each item, the names of the websites, operators of the websites, producers of the websites, and evaluation information of the websites to an information data searching unit (15) and registers and stores the transmitted information in an awarded corporation database (152).

2. The method for operation a service for evaluating and awarding websites according to claim 1, wherein in the registration type selecting step (S2), in classifying the registered websites into common registration website and award nomination registration website according to selective request of the individual website evaluation applicant server (2), a fee is charged for the websites registered as award nomination in the name of review and registration fee.

3. The method for operation a service for evaluating and awarding websites according to claim 1, wherein in the evaluation board selecting step (S3), in classifying the user servers (3) admitted as a member into the special evaluation board server (31) and common evaluation board server (32), by applying selection criteria data regarding application qualification and application condition for the special evaluation board server (31), qualification as the special evaluation board server (31) is granted to only user servers meeting the selection criteria data, and incentive benefits associated with use of the service for evaluating and awarding websites are granted to such special evaluation board server (31).

4. The method for operation a service for evaluating and awarding websites according to claim 1, wherein the evaluation service operator server (1) extracts the user servers corresponding to corporations specialized for construction of websites from the user servers (3) admitted as a member based on information of admission thereof, and stores the information list regarding the extracted user servers specialized for construction of websites in a web specialized corporation database (151) provided in an information data searching unit (15), and allows the stored information list regarding for the user servers specialized for construction of websites to be searched and identified through a searching toolbar (153).

5. The method for operation a service for evaluating and awarding websites according to claim 1, wherein the evaluation service operator server (1) further provides lists of information regarding the corporations specialized for construction of websites, information regarding the corporations awarded in website evaluation and information regarding the websites participating in public collection for award obtained through the service for evaluating and awarding websites as periodically published data information of e-book form through registration information database (123).
